(19) United States
(12) Patent Application Publication
(10) Pub. No.: US 2008/0068740 A1
(43) Pub. Date: Mar. 20, 2008

(54) Method and apparatus for writing servo data and positioning head in a disk drive

(75) Inventors: Shinichirou Kouhara, Hino-shi (JP); Masahide Yatsu, Akishima-shi (JP); Masafumi Iwashiro, Ome-shi (JP); Hideo Sado, Ome-shi (JP); Katsuki Ueda, Ome-shi (JP); Seiji Mizukoshi, Nishitama-gun (JP); Shouji Nakajima, Kodaira-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/898,565

(22) Filed: Sep. 13, 2007

(30) Foreign Application Priority Data
Sep. 14, 2006 (JP) 2006-249824

(51) Int. Cl. G11B 21/02

(52) U.S. Cl. 360/75

(57) ABSTRACT

According to one embodiment, a disk drive having a disk medium on which servo data is recorded, and a control unit that controls the positioning of a head, moving the head to a target position on the disk medium in accordance with the servo data. The servo data contains servo-burst patterns written in units of servo-track pitches. A part of each servo-burs pattern is invalidated (trimmed).

### CROSS-REFERENCE TO RELATED APPLICATIONS

This application is based upon and claims the benefit of priority from Japanese Patent Application No. 2006-249824, filed Sep. 14, 2006, the entire contents of which are incorporated herein by reference.

### BACKGROUND

1. Field

One embodiment of the present invention relates to a method and apparatus for writing servo data on a disk medium and for controlling the positioning of a head by using the servo data.

2. Description of the Related Art

In most disk drives, a representative example of which is a hard disk drive, servo data (servo pattern) is recorded in the disk medium. i.e., recording media, which is used to control the positioning of the heads. In each disk drive, the servo data read by the heads from the disk medium is used to move the heads to target positions (i.e., target tracks or target cylinders) on the disk medium.

The servo data has been recorded on the disk medium in the servo-writing step performed in manufacturing the disk drive, before or after the disks are incorporated into the disk drive. In the servo-writing step, an apparatus called a servo-track writer (STW) is usually used to write the servo data on the disk medium.

The disk drives developed in recent years have an increased storage capacity. In other words, tracks are formed in higher density on each disk medium than before. It therefore takes a longer time to write servo data on each disk medium. The increase in the servo-data writing time inevitably lowers the efficiency of the manufacture of the disk drive.

In view of this, various methods have been proposed, aiming at raising the efficiency of writing the servo data. In one method, the base servo data, i.e., first servo pattern, is written at a track pitch other than the half-track pitch (½-track pitch), and the second servo pattern used in the drive (product) is written at the ½-track pitch on the basis of the base servo pattern by the self-servo writing (SSW). (See, for example, Japanese Patent No. 2001-143416).

In the process of writing the base servo pattern at a pitch other than the ½-track pitch, the base pattern may be written at, for example, a 1/1-track pitch (i.e., one-track pitch). In this case, the servo-writing time can be indeed shortened. In an ordinary disk drive (product), however, the servo data recorded at any pitch other than ½-track pitch cannot serve to move any head to the centerline of a servo track.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of a disk drive according to an embodiment of the present invention;

FIG. 2 is a diagram explaining a concentric servo pattern according to the embodiment;

FIG. 3 is a diagram explaining a spiral servo pattern according to the embodiment;

FIG. 4 is a diagram explaining a process of writing the concentric base-servo pattern according to the embodiment;

FIG. 5 is a diagram explaining a process of writing the spiral servo pattern according to the embodiment;

FIG. 6 is a diagram explaining a servo-writing process performed in the embodiment;

FIGS. 7A to 7D are diagrams explaining various examples of a servo-data pattern according to the embodiment;

FIGS. 8A and 8B are diagrams showing the waveforms of signals read and representing servo-burst data according to the embodiment;

FIGS. 9A and 9B are diagrams showing the waveforms of signals read and representing servo-burst data corrected in the embodiment;

FIG. 10 is a diagram representing the head positions calculated in the embodiment; and

FIG. 11 is a flowchart explaining the sequence of the servo-burst data correcting process performed in the embodiment.

### DETAILED DESCRIPTION

Various embodiments according to the invention will be described hereinafter with reference to the accompanying drawings. In general, according to one embodiment of the invention, there is provided a disk drive that has a disk medium on which servo data is written, the servo data containing servo-burst patterns written at, for example, track pitches (1/1-track pitches), each having a part invalidated (trimmed), and control means for controlling the positioning of a head at a target position over the disk medium, by using the servo data.

(Configuration of the Disk Drive)

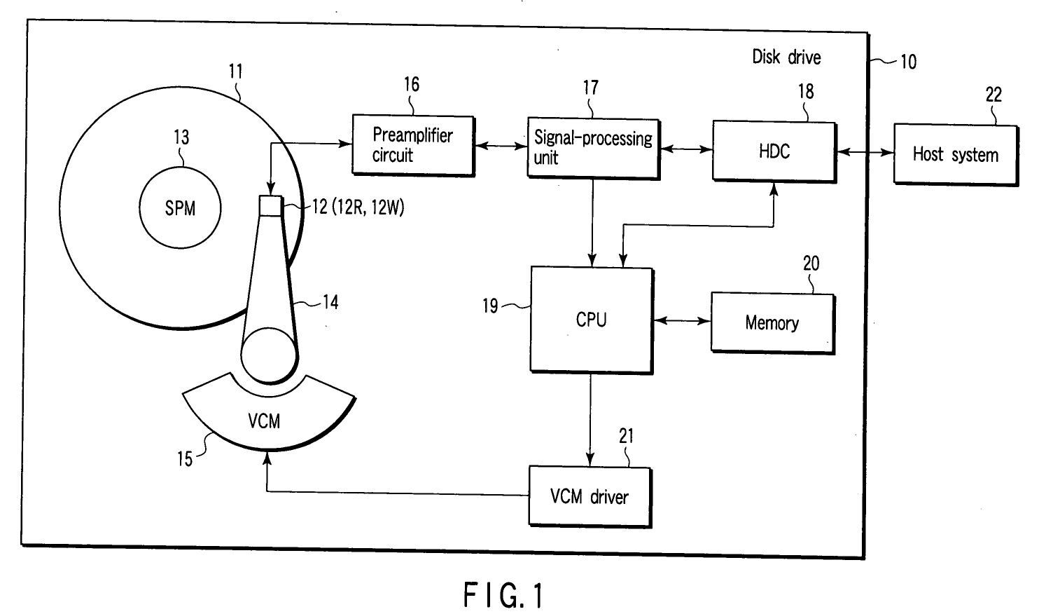

FIG. 1 is a block diagram showing the configuration of a disk drive according to this embodiment.

A disk drive 10 according to this embodiment has a head 12 and a spindle motor (SPM) 13. The SPM 13 holds and rotates the disk medium 11 (i.e., magnetic recording medium) at high speed. The head 12 includes a read head 12R and a write head 12W. The read head 12R reads data from the disk medium 11. The write head 12W writes data on the disk medium 11.

The data contains servo data and user data. The servo data is used to control the positioning of the head 12.

The head 12 is mounted on an actuator 14 that is driven by a voice coil motor (VCM) 15. The VCM 15 is supplied with a drive current from a VCM driver 21 and is driven and controlled. The actuator 14 is driven and controlled by the CPU 19 as will be described later. It is a carriage mechanism that moves the head 12 to, and positions the same, at a target position (target track) on the disk medium 11.

The disk drive 10 has a preamplifier circuit 16, a signal-processing unit 17, a disk controller (HDC) 18, a CPU 19 and a memory 20, in addition to the head-disk assembly described above.

The preamplifier circuit 16 has a read amplifier and a write amplifier. The read amplifier amplifies the read-data signal output from the read head 12R of the head 12. The write amplifier amplifies a write-data signal and supplies the signal to the write head 12W. More precisely, the write amplifier converts the write-data signal output from the signal-processing unit 17 to a write-current signal, which is supplied to the write head 12W.

The signal-processing unit 17, which processes read-data signals and write-data signals, is also known as a “read/write channel.” A read-data signal and a write-data signal contain not only a signal corresponding to the user data, but also a servo signal corresponding to the servo data. The signal-processing unit 17 includes a servo decoder that reproduces servo data from a servo signal.

The HDC 18 can function as an interface between the disk drive 10 and a host system 22 (e.g., personal computer or any one of various digital apparatuses). The HDC 18 performs the transfer of read data and write data between the disk medium 11 and the host system 22.

The CPU 19 is the main controller in the disk drive 10. The CPU 19 controls the VCM driver 21, which in turn controls the actuator 14. The positioning of the head 12 is thereby carried out. The CPU 19 uses the servo data (drive-servo pattern, later described) recorded on the disk medium 11 to control the positioning of the head 12. The memory 20 includes a RAM and a ROM, in addition to a flash memory (EEPROM, i.e., a nonvolatile memory). It stores various data items and programs that control the CPU 19.

(Servo Pattern)

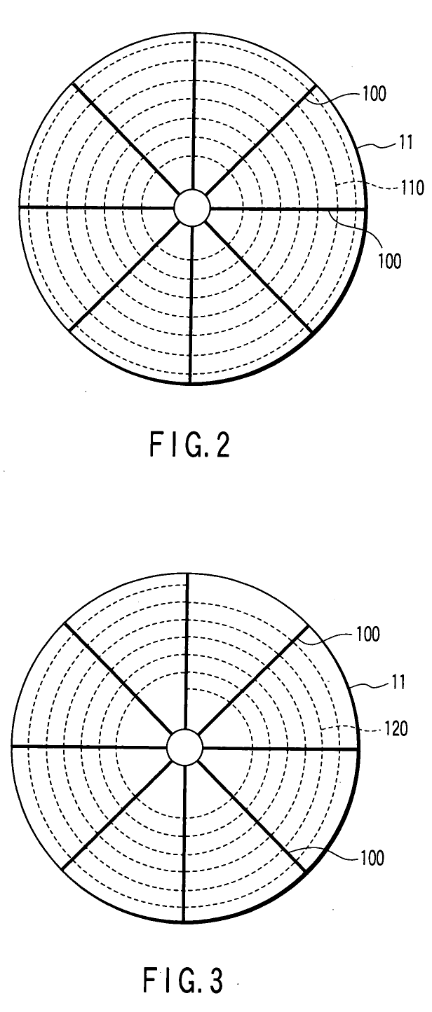

Generally, there are two types of servo patterns, one of which is recorded on any disk medium provided in disk drives. They are a concentric servo pattern and a spiral servo pattern. As shown in FIG. 2, a concentric servo pattern constitutes concentric servo tracks 110. In the concentric servo pattern, servo data items 100 are recorded on radial lines, and concentric servo tracks 110 connect the servo data items 100 at the borders of sectors. The word “sector” means a servo area in which a servo data item 100 is recorded.

As shown in FIG. 3, a spiral servo pattern constitutes a spiral servo track 120. In the spiral servo pattern, servo data items 100 are recorded on radial lines as in the concentric servo pattern, and the spiral servo tracks 120 connects the servo data items 100 at the borders of sectors.

The servo data, no matter whether it is concentric or spiral, includes address codes and a servo burst data (burst signals A, B, C and D). The address codes identify the tracks and sectors, respectively. The servo burst data is used to detect head-positioning errors in each track.

(Servo-Writing Process)

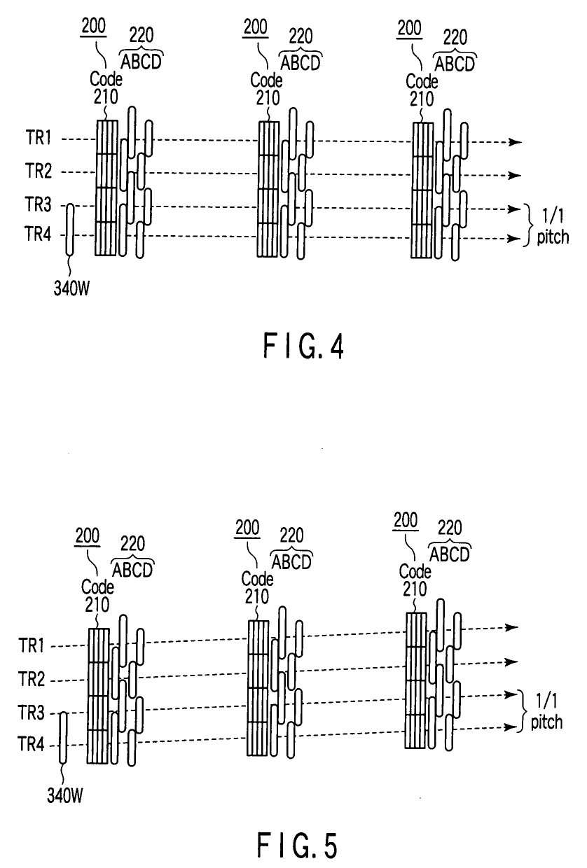

The servo-writing process according to the present embodiment will be explained, with reference to FIGS. 4 to 6 and FIGS. 7A to 7D.

The servo-writing method according to this embodiment uses a servo-track writer (STW) dedicated to the servo writing, during the manufacture of the disk drive. The servo-track writer records servo data (servo pattern) 200 on the disk medium 11 incorporated in the disk drive 10.

The servo data 200 contains address codes 210 and servo-burst data 220 (burst patterns A, B, C and B). Each address code 210 includes a track address (cylinder code) and a sector code. The track address identifies one track (cylinder). The sector code identifies one sector. The servo-burst data 220 is data for detecting a head-positioning error in the track (i.e., error of positioning the head with respect to the centerline of the track).

As shown in FIG. 4, the servo-track writer has a servo-write head 340W that has a recording width about 1.5 times the width of the servo track constituted in accordance with the servo data 200. TR1 to TR4 shown in FIG. 4 are the centerlines of the servo tracks provided on the disk medium 11.

If the write head 12W of the disk drive 10 records the user data while it remains at the center line of the servo track, a data track will be formed. Thus, the centerline of the servo track is aligned with the centerline of the data track formed.

In the process of writing the servo data in the present embodiment, the servo-write head 340W of the servo-track writer is moved at a one-track pitch (1/1-track pitch), which is equal to the width of the servo track, making the servo-write head 12W write the servo data 200. A servo area is thereby formed on the disk medium 11, in which the servo data 200 is recorded. As shown in FIG. 4, the servo data 200 consists of data items recorded at regular intervals in the circumferential direction of the medium 11, forming servo tracks (TR1 to TR4) that constitute a concentric servo pattern.

In this servo-data writing method, the STW needs to move and stop the servo-write head 340W only four times in order to write servo data for, for example, four servo tracks (cylinders). On the other hand, in the conventional servo-data writing method, the write head is moved at a half-track pitch (½-track pitch) to write the servo data. Hence, the write head must be repeatedly moved and stopped eight times to write servo data for, for example, four servo tracks. Thus, the servo-data writing method according to the present embodiment can write the servo data within about half the time required in the conventional method.

FIG. 5 explains how the servo data 200 is recorded on the disk medium 11, forming, for example, four servo tracks (TR1 to TR4) that constitute a spiral servo pattern. To record the servo data 200 in this way, it suffices to rotate the disk medium 11 four times while moving the write head at a constant angular velocity in the servo-data writing method according to the present embodiment.

In the ordinary method of writing a spiral servo pattern, the head is moved at a constant angular velocity, while the disk medium is being rotated eight times, in order to write servo data for four servo tracks. Hence, the servo-data writing method according to the present embodiment can write a spiral servo pattern within about half the time required in the conventional method.

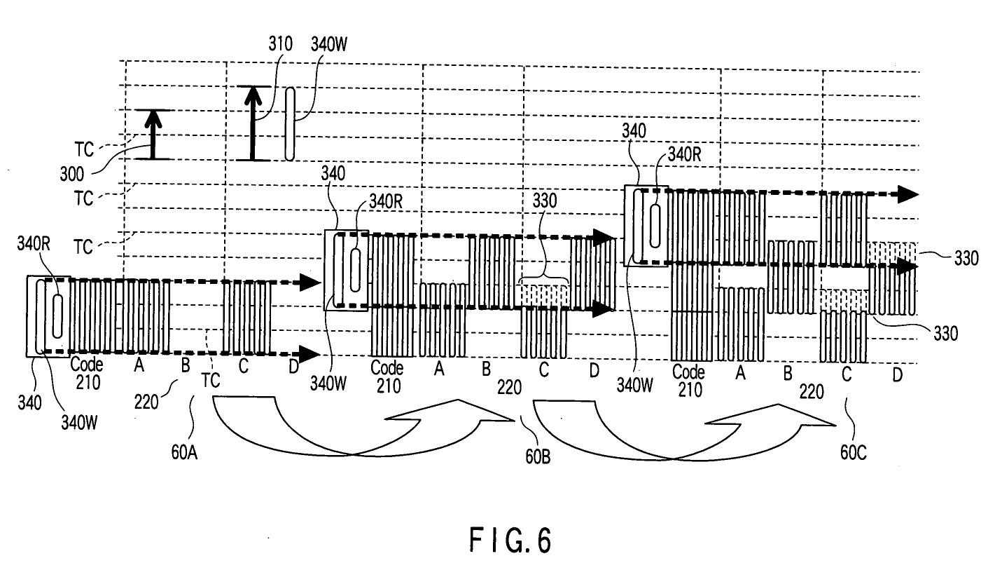

FIG. 6 is a diagram explaining a process of wiring servo data, which is performed in the present embodiment. More precisely, FIG. 6 explains a process of writing a concentric servo pattern.

The servo-track writer has a servo-read head 340R, in addition to the servo-write head 340W that has a recording width (i.e., write-head width) about 1.5 times the width of the servo track. The servo-write head 340R writes servo data. The servo-read head 340R reads the servo data, which is used to control the positioning of the servo-write head 340W.

How the servo data is written will be explained. First, as shown at 60A in FIG. 6, the servo-write head 340W writes an address code 210 and the burst patterns A and C of a servo-burst data 220.

Next, as shown at FIG. 60B in FIG. 6, the servo-write head 340W of the servo-track writer is moved by a one-servo-track pitch over the disk medium 11 in the radial direction thereof. While so moved, the head 340W writes the address code 210 and the burst patterns B and D of the servo-burst data 220.

As shown at 60A in FIG. 6, an area 300 is a region that is as broad as one servo-track pitch as illustrated at 60A in FIG. 6, as measured perpendicular to the track centerline TC, an area 310 is a region that is as broad as the servo-write head 340W, i.e., 1.5 servo-track pitches.

As shown at 60B in FIG. 6, the servo-track writer trims a part 330 of the burst pattern C, while writing the burst patterns B and D. The trimming is a process of invalidating the data recorded, which is equivalent to deletion of signals. As a result, only one servo-track part of the burst pattern C written in the process shown at 60A in FIG. 6 remains recorded. In other words, the burst pattern C is valid for one servo-track only. In this process, the burst pattern A is not trimmed and remains recorded in the area that is as broad as 1.5 servo-track pitches.

Then, as shown at 60C in FIG. 6, the servo-write head 340W of the servo-track writer is further moved by one servo-track pitch over the disk medium 11 in the radial direction thereof. While being so moved, the head 340W writes an address code 210 and the burst patterns A and C of servo-burst data 220. At the same time, the servo-track writer writes the burst patterns A and C, it trims a part 330 of the burst pattern D. As a result, only one servo-track part of the burst pattern D written in the process shown at 60B in FIG. 6 remains recorded. In other words, the burst pattern D is valid for one servo-track only. In this process, the burst pattern B is not trimmed and remains recorded in the area that is as broad as 1.5 servo-track pitches.

In this servo-data writing method, the servo data 200 constituting servo tracks (each having a track centerline TC) can be recorded on the disk medium 11, while the servo-write head 340W is being moved in units of servo-track pitches. In this case, the servo-burst data 220 contains the servo-burst patterns A and B recorded in an area as broad as 1.5 servo-track pitches and the servo-burst patterns C and D trimmed and now recorded in an area as broad as one servo track. That is, the servo patterns C and D are data recorded in an area that is as broad as area 300.

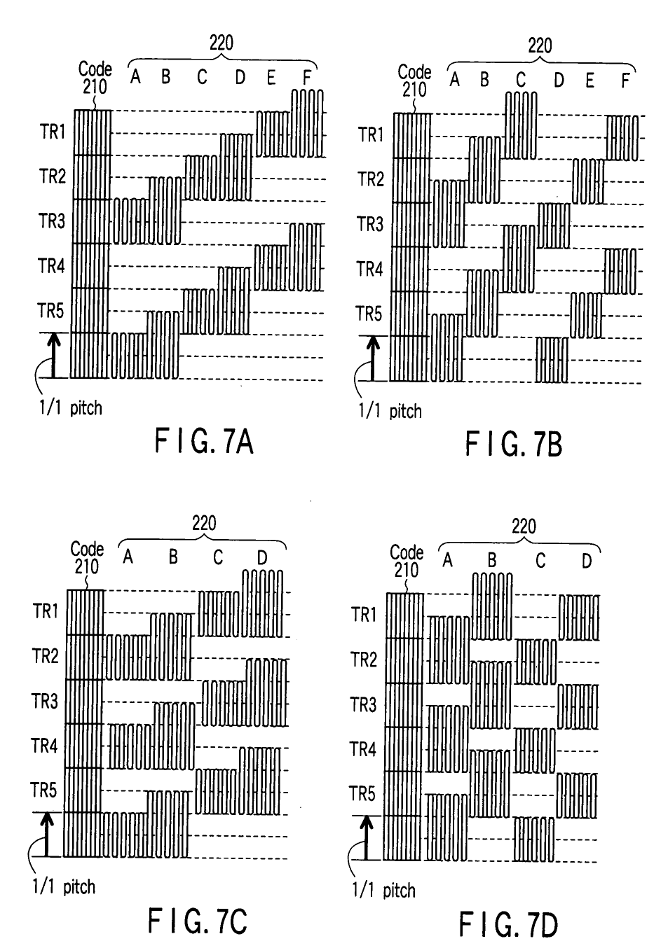

FIGS. 7A to 7D are diagrams explaining various examples of a servo-data pattern that may be recorded on the disk medium 11 by the servo-writing method according to the present embodiment;

FIG. 7A shows a pattern of servo-burst data 220 that contains servo-burst patterns B, D and F recorded in an area as broad as 1.5 servo-track pitches and servo-burst patterns A, C and E trimmed and now recorded in an area as broad as one servo track. FIG. 7B shows a pattern of servo-burst data 220 that contains servo-burst patterns A, B and C recorded in an area as broad as 1.5 servo-track pitches and servo-burst patterns D, E and F trimmed and now recorded in an area as broad as one servo track.

FIG. 7C shows a pattern of servo-burst data 220 that contains servo-burst patterns B and D recorded in an area as broad as 1.5 servo-track pitches and servo-burst patterns A and C trimmed and now recorded in an area as broad as one servo track. FIG. 7D shows a pattern of servo-burst data 220 that contains servo-burst patterns A and B recorded in an area as broad as 1.5 servo-track pitches and servo-burst patterns C and D trimmed and now recorded in an area as broad as one servo track.

(Control of the Positioning of the Head)

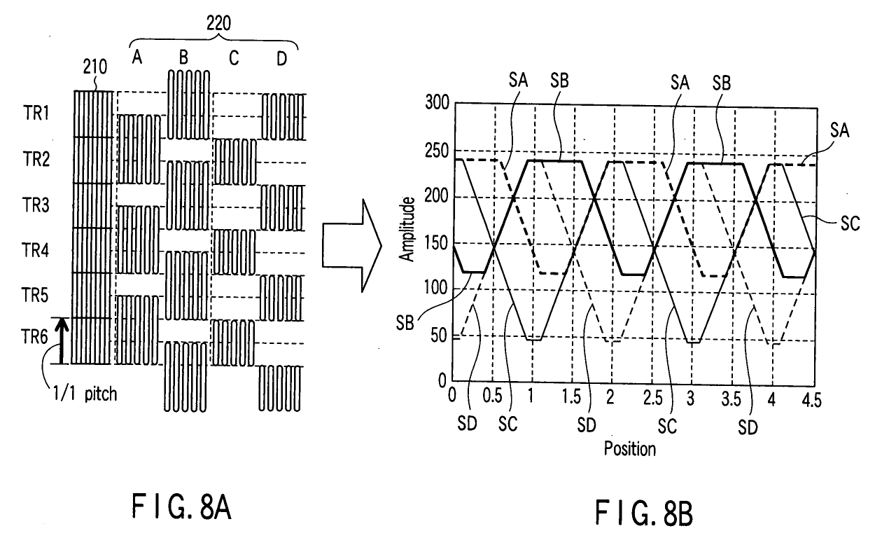

How the positioning of the head 10 is controlled by using the servo data 200 in the disk drive 10 according to this embodiment will be explained with reference to FIGS. 8A and 8B, FIGS. 9A and 9B and FIGS. 10 and 11.

In the disk drive 10, the CPC 19 drives the VCM driver 21, which in turn controls the actuator 14. The positioning of the head 12 is thereby controlled. More specifically, the CPU 19 detects the position the head 12 takes at present, from the servo data 200 recorded on the disk medium 11. In accordance with the position thus detected, the head 12 is moved to a target position (target track) on the disk medium 11.

The read head 12R reads the servo data 200 from the disk medium 11. The servo decoder incorporated in the signal-processing unit 17 reproduces the servo data 200. From the servo data 200 reproduced, the CPU 19 detects the track at which the read head 12R is positioned now, in accordance with the address code 210.

Further, the CPU 19 detects the position the read head 12R assumes in the track, in accordance with the servo-burst data 220 contained in the servo data 200 thus reproduced. The servo-burst data 220 is composed of burst patterns A to D arranged at regular intervals and different in phase.

The servo decoder reproduces position data (amplitudes A to D or bursts A to D) representing the position the read head 12R assumes in the servo track, from the read signal that corresponds to the burst patterns A to D read by the read head 12R. The CPU 19 calculates the position of the read head 12R from the position data (amplitudes C and D), determining the position error, i.e., a distance from the servo-track center of the read head 12R. The CPU 19 therefore detects a position error of the read head 12R, a distance from the boundary between the servo track of the read head 12R and a track immediately adjacent to the servo track.

The servo-burst data 220 may have such a pattern as shown in FIGS. 7A and 7B. That is, it may be composed of burst patterns A to F.

In the present embodiment, a burst pattern is recorded on the disk medium, as servo-burst data 220. As shown in FIG. 8A, the servo-burst data 220 contains servo-burst patterns A and B recorded in an area as broad as 1.5 servo-track pitches and servo-burst patterns C and D trimmed and now recorded in an area as broad as one servo-track pitch.

FIG. 8B shows the waveforms of the read signals that the read head 12R generate when it reads the servo-burst data 220. In FIG. 8B, track positions are plotted on the abscissa, and the amplitudes of read signals SA to SD corresponding to servo-burst patterns A to D are plotted on the ordinate. Track position “1” corresponds to a position on the centerline of track TR shown in FIG. 8A. Similarly, track positions “2,” “3” and “4” correspond to positions on the centerlines of tracks TR2, TR3 and TR4, respectively.

The CPU 19 calculates the position of the read head 12R by using the digital values of the amplitudes (A to D) of the read signals SA to SD that correspond to the burst patterns A to D. The CPU 19 then determines the actual position of the read head 12R (i.e., position error). More specifically, the CPU 19 performs an operation of (A−B)/(A+B), finding a position error of the read head 12R. If A=B, the CPU 19 determines that the read head 12R is located on the centerline of the track. Further, the CPU 19 performs an operation of (C−D)/(C+D), finding a position error of the read head 12R, or a distance from the boundary between the track and an immediately adjacent track. That is, the CPU 19 detects that the read head 12R is positioned at the boundary between these tracks, if amplitude C and amplitude D are equal, or C=D.

Alternatively, the CPU 19 may perform an operation of {(A−B)*|A−B|(n−1)}/{(|A−B|ⁿ+|C−D|ⁿ)}, where 1≦n≦2.

In the present embodiment, the burst pattern 220 contains, as shown in FIG. 8A, servo-burst patterns A and B recorded in an area as broad as 1.5 servo-track pitches and servo-burst patterns C and D trimmed and now recorded in an area as broad as one servo-track pitch. Hence, the CPU 19 cannot determine the position of the read head 12 by calculating the position in such a way as described above.

More precisely, the amplitude A of read signal SA and the amplitude B of read signal SB are not equal (that is A≠B) if the read head 12R is positioned on the centerline of the track TR1. In other words, the signals SA and SB have amplitudes A and B that correspond to the track position “1” plotted on the abscissa in FIG. 8B.

Hence, the CPU 19 corrects the amplitudes of the signals SA to SD which have been read by the read head 12R and which correspond to the burst patterns A to D. The CPU 19 therefore detects the position of the read head 12R by performing the calculation of the equation specified above.

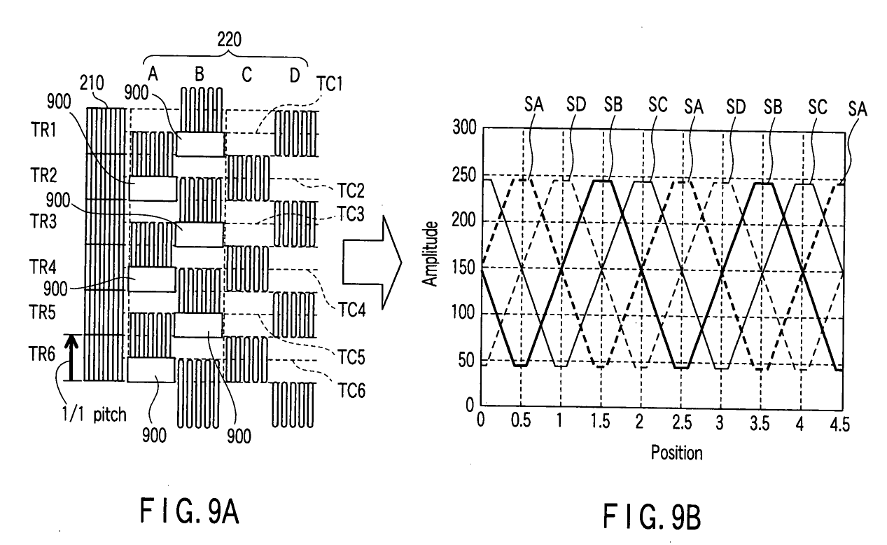

FIG. 9B shows the waveforms of the signals that have been read by the read head 12R and which represent the amplitudes of read signals SA to SD. FIG. 9A shows the unnecessary parts 900 of the servo-burst patterns A and B, which are used in the present embodiment and which are recorded in an area as broad as 1.5 servo-track pitches.

The CPU 19 uses, as correction values A and B, the value (trimming values) obtained by subtracting the amplitude corresponding to an unnecessary part 900 (FIG. 9A) from the amplitude values corresponding to the servo-burst patterns A and B, respectively.

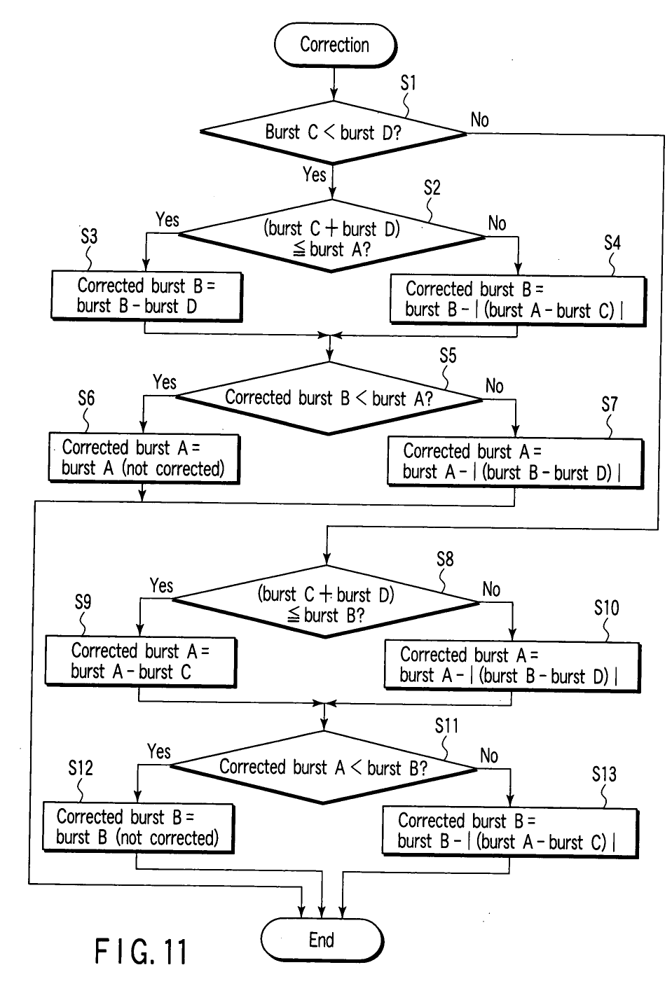

FIG. 11 is a flowchart explaining the sequence of a process the CPU 19 performs to correct the servo-burst data 220, namely the amplitudes of the signals SA to SD. In FIG. 11, the amplitudes of the signals SA to SD read by the read head 12R are indicated as bursts A to D, and the amplitudes A and B corrected are indicated as corrected bursts A and B.

Assume that the head 12 is positioned near the tracks TR1 to TR3 as shown in FIG. 9A.

Then, the CPU 19 compares the bursts C and D, which are two of the four bursts read by the read head 12R (Step S1). If the burst D is greater than the burst C, the CPU 19 determines that the read head 12R is closer to the track TR1 or TR3 than to the boundary between the tracks TR1 and TR2 (YES in Step S1).

In this case, the CPU 19 compares the sum of the bursts C and D with the burst A (Step S2). If the sum of the bursts C and D is equal to or smaller than the burst A, the CPU 19 determines that the read head 12R is positioned at the track TR1 (YES in Step S2). In this case, the CPU 19 performs the operation of “corrected burst B=burst B−burst D” in order to trim the unnecessary part 900 of the burst pattern B. The burst pattern B is thereby corrected (Step S3).

The sum of the bursts C and D may exceed the burst A (NO in Step S2). If this is the case, the CPU 19 determines that the read head 12R is positioned at the Track TR3, and performs the operation of “corrected burst B=burst B−|burst A−burst C|” (Step S4). Hence, the corrected burst B is equal to the burst B.

Next, the CPU 19 compares the corrected burst B with the burst A (Step S5). If the corrected burst B is smaller than the burst A (YES in Step S5), the CPU 19 determines that the read head 12R is positioned at the track TR1. In this case, the CPU 19 does not correct the burst A (Step S6).

The corrected burst B may be equal to or greater than the burst A (NO in Step S5). If this is the case, the CPU 19 determines that the read head 12R is positioned at the track TR3, and performs the operation of “corrected burst A=burst A−|burst B−burst D|” (Step S7). Hence, the corrected burst A is equal to the burst A.

Thus, the position of the head 12 is calculated from the burst A and the corrected burst B (i.e., burst B generated by trimming the unnecessary part 900), and the head 12 is positioned at either the centerline TC1 of the track TR1 or the center line TC3 of the track TR3.

The CPU 19 may determine that the burst C is equal to or greater than the burst D (NO in Step S1). In this case, it can be determined the read head 12R is positioned at the track TR2.

Next, the CPU 19 compares the sum of the bursts C and D with the burst B (Step S8). If the sum of the bursts C and D is equal to or smaller than the burst B (YES in Step S8), the CPU 19 determines that the read head 12R is positioned at the track TR2 and close to the track TR3. In this case, the CPU 19 performs the operation of “corrected burst A=burst A—burst C,” trimming the unnecessary part 900 of the burst pattern A and thus correcting the burst A (Step S9).

If the sum of the bursts C and D is greater than the burst B (NO in Step S8), the CPU 19 determines that the read head 12R is positioned at the track TR2 and close to the track TR1. In this case, the CPU 19 performs the operation of “corrected burst A=burst A−|burst B−burst D|.” As a result, the corrected burst A is identical to the burst A (Step S10).

Further, the CPU 19 compares the corrected burst A with the burst B (Step S11). If the corrected burst A is smaller than the burst B (YES in Step S11), the CPU 19 determines that the read head 12R is positioned at the track TR2 and close to the track TR3. In this case, the CPU 19 does not correct the burst B (Step S12).

If the corrected burst A is equal to or greater than the burst B (NO in Step S11), the CPU 19 determines that the read head 12R is positioned at the track TR2 and close to the track TR1. In this case, the CPU 19 performs the operation of “corrected burst B=burst B−|burst A−burst C|.” As a result, the corrected burst B is identical to the burst B (Step S13).

Thus, the CPU 19 calculates the position of the head 12 from the burst B and the corrected burst A (i.e., burst A generated by trimming the unnecessary part 900), and the head 12 is positioned at the centerline TC2 of the track TR2.

As has been described, the present embodiment can provide a disk drive 10 that incorporates a disk medium 11 on which servo data 200 has been recorded by a servo-track writer comprising a servo-write head 340W that has a recording width about 1.5 times the width of the servo track.

In this disk drive 10, the servo data 200 can be written on the disk medium 11 while the servo-write head 340W is being moved at a one-track pitch, i.e., the same pitch as the servo-track pitch. It therefore suffices to move and stop the servo-write head 340W only four times to write servo data for, for example, four servo tracks. Hence, the servo-data writing method according to this embodiment can write the servo data within about half the time required in the conventional method in which the write head is moved at ½-track pitch to write the servo data.

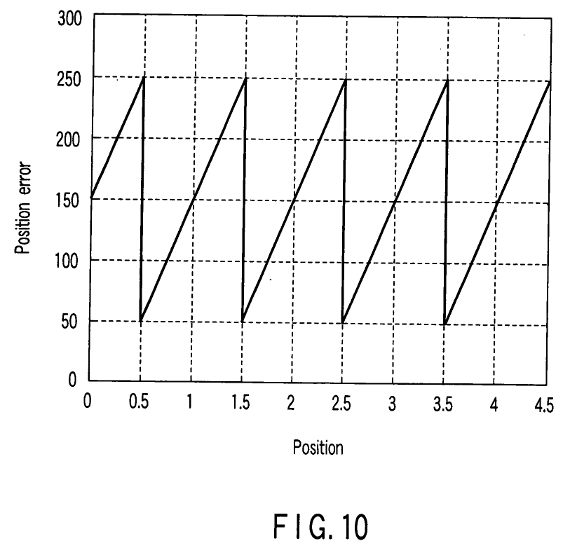

On the disk medium 11 according to this embodiment, a burst pattern is recorded as the servo-burst data 220 included in servo data 200, which contains the servo-burst patterns A and B recorded in an area as broad as 1.5 servo-track pitches and the servo-burst patterns C and D trimmed and recorded in an area as broad as one servo-track pitch. To control the positioning of the head, the CPU 19 performs the process of correcting the servo-burst patterns A and B recorded in an area as broad as 1.5 servo-track pitches and utilizes the conventional operation for detecting the head position (position-error calculation), thereby to position the head as desired. Hence, as shown in FIG. 10, the CPU 19 can calculate the head position with the same accuracy as possible with the conventional head-position calculation.

Thus, the present embodiment can shorten the servo-writing time, i.e., time for writing servo data on a disk medium. In addition, the positioning of the head can be reliably controlled by using the servo data recorded on the disk medium.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a head which has a write head element configured to write data and a read head element configured to read data;
a disk medium which is a data-recording medium, on which the data is recorded, and which has a servo-data area in which servo data is recorded, the servo data containing address codes identifying the servo tracks provided in the servo-data area and servo-burst data used to detect a position in each servo track, the servo-burst data being composed of burst patterns in different phases, which are recorded in an area broader than the width of the servo tracks, and that part of each burst pattern which corresponds to an extra region of the area being invalidated; and
a control unit which uses the servo data read from the servo-data area by the read head element, thereby to control the positioning of the head.

2. The disk drive according to claim 1, wherein the servo-burst data recorded on the disk medium contains burst patterns A and B, each recorded in an area broader than the width of the servo tracks, and burst patterns C and D, each having a part recorded in an extra part of the area and invalidated.

3. The disk drive according to claim 1, wherein the control unit corrects position data about any burst pattern that has a part recorded in an extra part of the area, in order to position the head at the centerline of the servo track identified by an address code, by using the servo-burst data read by the read head element, calculates a position from position data reproduced from the servo-burst data and containing the position data corrected, performs an operation for detecting a position, and detects the position that the head assumes in the servo track.

4. The disk drive according to claim 1, wherein the servo-burst data recorded on the disk medium contains burst patterns recorded in an area as broad as 1.5 servo-track pitches and burst patterns, each recorded in an area broader than the width of the servo tracks and having a part recorded in an extra part of the area and invalidated.

5. The disk drive according to claim 1, wherein the servo-burst data recorded on the disk medium contains burst patterns A and B recorded in an area as broad as 1.5 servo-track pitches and burst patterns C and D, each recorded in an area broader than the width of the servo tracks and having a part recorded in an extra part of the area and invalidated.

6. The disk drive according to claim 1, wherein the servo-burst data recorded on the disk medium contains burst patterns A and B recorded in an area as broad as 1.5 servo-track pitches and burst patterns C and D, each recorded in an area broader than the width of the servo tracks and having a part recorded in an extra part of the area and invalidated; and the control unit corrects position data about the burst pattern A or B in order to position the head at the centerline of the servo track identified by an address code, by using the servo-burst data read by the read head element, calculates a position from position data about the burst patterns A and B, which contains the position data corrected, detects, from the position calculated, a position error of the head with respect to the centerline of the servo track, calculates a position from position data about the burst patterns C and D, and detects, from the position calculated, a position error of the head with respect to a boundary between the servo rack and a servo track adjacent thereto.

7. A method of writing servo data containing address codes and servo-burst data, on a disk medium used in a disk drive, the method comprising:
moving a servo-write head over the disk medium in units of servo-track pitches, the servo-write head having a recording width larger than the width of servo tracks provided on the disk medium; and
writing the servo data on the disk medium by using the servo-write head.

8. The method according to claim 7, wherein the servo data contains address codes identifying the servo tracks provided in a servo-data area and servo-burst data used to detect a position in each servo track, and the servo-burst data is composed of burst patterns in different phases, which are recorded in an area broader than the width of the servo tracks, and that part of each burst pattern which corresponds to an extra region of the area being invalidated.

9. The method according to claim 7, wherein the writing is to write servo-burst data which contains burst patterns A and B, each recorded in an area broader than the width of the servo tracks, and burst patterns C and D, each having a part recorded in an extra part of the area and invalidated.

10. The method according to claim 7, wherein the servo-write head has a recording width about 1.5 times as large as the width of the servo tracks.

11. The method according to claim 1, wherein the servo-write head has a recording width about 1.5 times as large as the width of the servo tracks and writes the servo-burst data which contains burst patterns recorded in an area as broad as 1.5 servo-track pitches and burst patterns, each recorded in an area broader than the width of the servo tracks and having a part recorded in an extra part of the area and invalidated.

12. The method according to claim 7, wherein the servo-write head has a recording width about 1.5 times as large as the width of the servo tracks and writes the servo-burst data which contains burst patterns A and B recorded in an area as broad as 1.5 servo-track pitches and burst patterns C and D, each recorded in an area broader than the width of the servo tracks and having a part recorded in an extra part of the area and invalidated.
